(19) United States
(12) Patent Application Publication
(10) Pub. No.: US 2008/0118033 A1
(43) Pub. Date: May 22, 2008

(54) ANTISCATTER GRID ARRANGEMENT

(75) Inventor: Remy Klausz, Neuilly sur Seine (FR)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/560,430

(22) Filed: Nov. 16, 2006

(51) Int. Cl. G21K 1/02; B29C 65/54

(52) U.S. Cl. 378/154; 156/182

(57) ABSTRACT

An antiscatter grid arrangement for absorbing scattered radiation is provided. The arrangement includes a series of grid elements, including a first grid element attached to a second grid element. Each first and second grid element includes a lamella of high radiation attenuation located between a first and a second interspace band of low radiation attenuation. The arrangement also includes a fixed connection between one of the first and second interspace bands of the first grid element to one of the first and second interspace bands of the second grid element.

### BACKGROUND OF THE INVENTION

The subject matter described herein generally relates to x-ray imaging and more particularly, to an antiscatter grid arrangement employed to reduce scattered radiation emerging from an imaged object.

An x-ray imaging apparatus usually comprises at least a source of X-rays and an image receptor located in front of the source to receive the x-ray beam, in such a way that before reaching the image receptor the x-ray beam emerging from the source traverses the object being imaged, and is attenuated by said object.

Due to the nature of the attenuation phenomena inside the object, some of the radiation is simply absorbed inside the object; among the radiation emerging out of the object being imaged, a primary portion passes directly through it without interaction. There is also a secondary portion, which after interaction with the object, scatters and of which some part may reach the image receptor. This secondary portion of the radiation, also known as scattered radiation or x-ray scatter, generally degrades the contrast of the acquired image and is undesired.

Certain antiscatter grid devices have been developed to reduce scattering secondary radiation. These certain antiscatter grid devices include constructions of low attenuation material and high attenuation lamella.

There is a need for an antiscatter grid apparatus having reduced local deformation or distortions in the high attenuation lamella. These local deformations and distortions can produce undesired artefacts in the acquired image, known as “mottle artefacts”, particularly in X-ray mammography. These local distortions in the high attenuation lamella also increase opportunities for cumulative errors in the angular position of the high attenuation lamella that can reduce performance of the antiscatter grid apparatus.

### BRIEF DESCRIPTION OF THE INVENTION

The above-mentioned need is addressed by the embodiments described herein in the following description.

In one embodiment, an antiscatter grid element is provided. The grid element includes a first interspace band and a second interspace band of low radiation attenuation attached at opposed faces of a lamella of high radiation attenuation. The first and second interspace bands each include an open face in a central longitudinal direction. The open face of each interspace band is operable to receive an open face of a first and a second interspace band of low radiation attenuation of another grid element.

In another embodiment, an antiscatter grid arrangement is provided. The antiscatter grid arrangement generally includes a plurality of grid elements, including a first grid element attached at a second grid element. Each first and second grid element includes a lamella of high radiation attenuation located between a first and a second interspace band of low radiation attenuation. The arrangement also includes a fixed connection between one of the first and second interspace bands of the first grid element to one of the first and second interspace bands of the second grid element.

In yet another embodiment, a method of fabricating an antiscatter grid arrangement is provided. The method comprises the acts of creating a plurality of grid elements, including a first grid element and a second grid element. The act of creating each of plurality of grid elements includes connecting a first interspace band comprised of a low radiation attenuation material at one face of a lamella comprised of a higher radiation attenuation, and connecting a second interspace band of low radiation attenuation material at an opposite face of the lamella, the first and second grid elements created independently of one another. The method further includes attaching one of the first and second interspace bands of one of the plurality of grid elements to one of the first and second interspace bands of another of the plurality of grid elements.

Embodiments of varying scope are described herein. In addition to the aspects described in this summary, further aspects will become apparent by reference to the drawings and with reference to the detailed description that follows.

### BRIEF DESCRIPTION OF THE DRAWINGS

FIG. 1 is a schematic diagram of an antiscatter grid arrangement.

FIG. 2 is a schematic diagram showing an exploded view of one of the grid elements of the antiscatter grid arrangement shown in FIG. 1.

FIG. 3 is a schematic diagram showing an embodiment of a method of fabricating the grid element shown in FIG. 2.

FIG. 4 is a schematic diagram showing another embodiment of a method of fabricating an embodiment of an anti-scatter grid arrangement.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

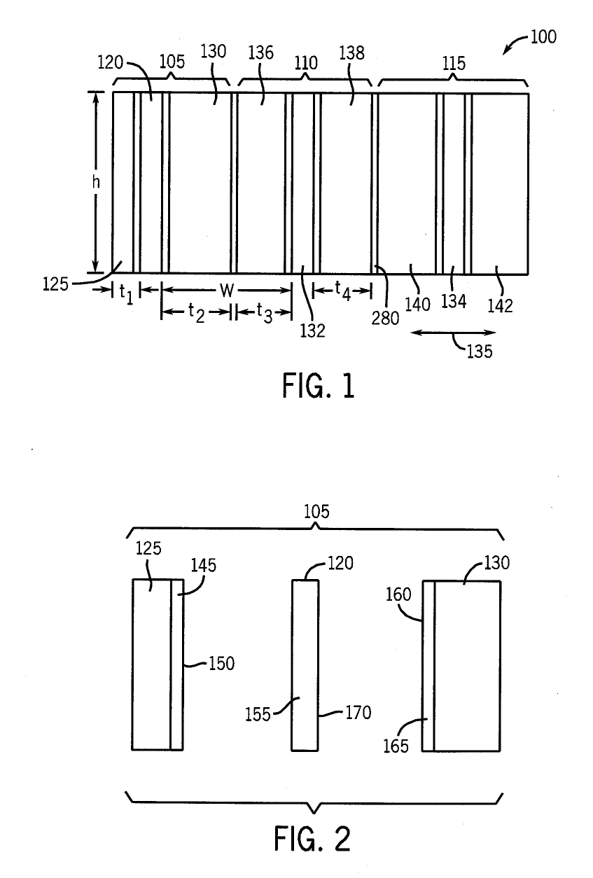

FIG. 1 illustrates an embodiment of an antiscatter grid arrangement 100 comprised of a series of grid elements 105, 110, 115 arranged to attenuate passage of radiation in a selective manner. One embodiment of the grid element 105 includes a lamella 120 located or sandwiched between a pair of interspace bands 125 and 130. The grid elements 110 and 115 include lamella 132 and 134, respectively sandwiched or pressed between interspace bands 136, 138 and 140, 142 of construction similar to the grid element 105.

Each lamella 120 is made of a material with high absorption properties for the x-rays the anti-scatter grid is intended to be used for. As an example, this material can combine a specific gravity higher than 5 g/cm³ with a composition comprising at least lead, gold, copper, tantalum, platinum, depleted uranium, tungsten or another metal or material of similar radiation attenuation characteristics used alone or in combination or in association with other materials. In one example, the high attenuation lamella 120 is made of copper coated with lead, the total thickness of a strip of metal being less than about 50 μm and the thickness of lead being in a range of about 5 and 30 μm. In another example, the high attenuation lamella 120 is made of lead, with a thickness of 10 to 30 μm.

Each interspace band 125 and 130 is comprised of a low attenuation material more transparent to radiation relative to the lamella. The first and second interspace bands 125 and 130 protect the lamella 120 against local distortions or defects and to preserve the flatness of the lamella 120 as the grid element is assembled with the other grid elements to create the grid arrangement. The interspace bands 125 and 130 of low attenuation material can be comprised of the same low radiation attenuation material or of different low radiation attenuation material. Examples of the low attenuation material can include at least one of aluminium or an aluminium composition, cellulose fibers (i.e., a variety of strong paper or thin cardboard), a thermoplastic material, or a polymer composition chosen from the group that includes polyethylene, methyl pentene copolymer, polyimide and biaxially-oriented polyethylene terephtalate. A specific example of the polymer composition is 4-methylpentene-1-based polyolefin, such as TPX™ as manufactured by MITSUI PETROCHEMICAL INDUSTIRES, LTD.™ TPX™ is generally radio transparent and has a density of about 0.83 g/cm³.

In accordance with the embodiment of the grid element 105 shown in FIG. 1, the first interspace band 125 of low attenuation material has a thickness (t1) less than a thickness (t2) of the second band 130 of low attenuation material in a longitudinal direction of the arrangement (illustrated by the arrow and reference 135). It should be understood that the thickness (t1) can alternatively be greater than the thickness (t2). Yet, the grid element 110 illustrates the interspace band 136 of thickness (t3) generally equal to a thickness (t4) of interspace band 138. The relation of the thicknesses of the low attenuation material of the grid elements 105, 110 and 115 can vary. The first and second interspace bands 125 and 130 of the grid element 105 can be comprised of the same or different low radiation attenuation material compositions. The number and types of low radiation attenuation materials comprising each grid element 105, 110, and 115 of the grid arrangement 100 can vary.

One characteristic of the antiscatter grid arrangement 100 is a distance between two most closely adjacent lamella 120 and 132, exemplified by a ratio of a height (h) of the lamella 120 relative to a width (W) between the most closely adjacent lamella 120 and 132. An exemplary range of the ratio (h/W) is about 3 to 17. In a particular example, the ratio (h/W) of the antiscatter grid arrangement 100 employed in mammography ranges from 3 to 6.

Referring now to FIG. 2, a first coating of a binding material 145 attaches or connects a face 150 of the interspace band 125 at a face 155 of the lamella 120. A second coating of binding material 160 attaches a face 165 of the interspace band 130 at a face 170 of the lamella 120, opposite the face 165. The coating of binding material 145 can be applied at either or both faces 150 and 155. Likewise, the coating of binding material 160 can be applied to either or both faces 165 and 170.

One embodiment of at least one of the coatings of binding material 145, 160 includes an adhesive comprised of an epoxy glue composition, yet the type of the adhesive can vary. In accordance with another embodiment, the coating of binding material 145 and 160 can include electrically conductive material operable to act as electrodes conducting electrically current for reasons to be described later.

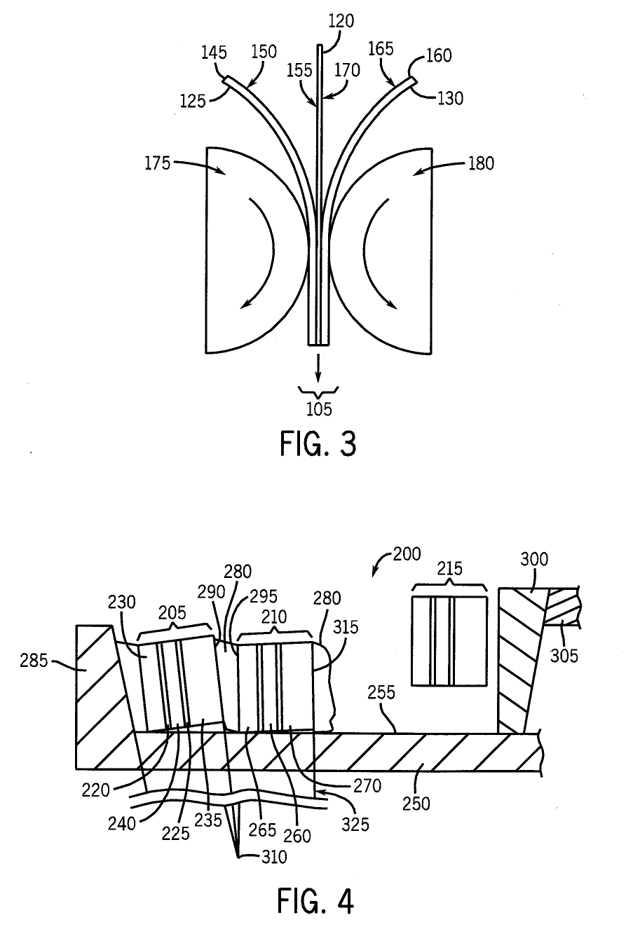

Referring to FIG. 3, one embodiment of a method of creating the grid element 105 includes simultaneously applying the coatings of binding material 145 and 160 as interspace bands 125 and 130 and the lamella 120 are continuously unrolled. The first coating of a binding material 145 attaches or is applied between the face 150 of the interspace band 125 and at the face 155 of the lamella 120. The second coating of binding material 160 attaches or is applied between the face 165 of the interspace band 130 and at the face 170 of the lamella 120. The coating of binding material 145 can be applied at either or both faces 150 and 155. Likewise, the coating of binding material 165 can be applied at either or both faces 165 and 170. The interspace bands 125 and 130 and the lamella 120 then pass through a pair of pressing rollers 175 and 180. The pressing rollers 175 and 180 rotate in opposite directions, pressing the interspace bands 125 and 130 toward one another so as to create a fixed connection with the lamella 120 between. A space between the pressing rollers 175 and 180 is just less or equal to the width of the grid element 105. The grid element 105 thus obtained is cut to the desired dimension so as to be incorporated in the grid arrangement 100 as described above. It should be understood that the grid elements 110 and 115 can be created in similar manner.

Having described a general construction of the embodiment of the grid arrangement 100 shown in FIG. 1, the following is an embodiment of a method of fabricating, assembling or creating an embodiment of a grid arrangement 200 comprised of a series of grid elements 205, 210, and 215 as shown in FIG. 4, similar in construction to the grid element 105 disclosed in FIGS. 2 and 3 as described above. It should be understood that the foregoing sequence of acts comprising the method can vary, that the method does not necessarily need to include each every act described herein, and the method can include additional acts not described herein.

The method of fabricating the antiscatter grid arrangement 200 includes creating the series of grid elements 205, 210 and 215. One embodiment of creating the grid element 205 includes applying coats of binding material 220 and 225 in abutment between interspace bands 230 and 235 and the lamella 240, similar to the coatings of binding material 145 and 160 described above. The coats of binding material 230 and 235 can be applied with the lamella 240 and interspace bands 230 and 235 at rest on a slab 250 having a generally level reference surface 255. Once the coats of binding material 220 and 225 are applied, rigid plates sandwich or press the interspace bands 230 and 235 toward one another so create a fixed connection with the lamella 240 between.

It should be understood that the above-described procedure can be used to position and assemble the remaining grid elements 210 and 215 of the grid arrangement 200. Assume now that at least the grid element 205 and the grid element 210 are now assembled, and that the grid element 210 includes a lamella 260 of high radiation attenuation between interspace bands 265 and 270 of low radiation attenuation similar to the grid element 205.

The method includes abutting and attaching the grid element 205 to the grid element 210 with a coating or layer of binding material 280. Assume, for sake of example, that the grid element 205 was created independently the grid element 210 and is positioned abutting a wedge 285 at rest on the slab 250. The other grid element 210 is also placed at rest on the slab 250 adjacent the grid element 205. The coat of binding material 280 can be applied at one or both open faces 290 and 295 of the interspace bands 265 and 270 of the grid elements 205 and 210 to be joined. Various types of coatings of binding material 280 and techniques of application can be used to connect the grid elements 205, 210, and 215 to one another. According to one embodiment, the coating of binding material 280 includes an adhesive applied to at least one of the most closely adjacent faces 285 and 290 of the interspace bands 235 and 265 of the grid elements 205 and 210, respectively. The coating or layer 280 of adhesive can present a thickness of 5 to 20 μm and is fluid or liquid. One embodiment of the adhesive includes a glue composition, such as an epoxy resin comprising a mix of a resin and a catalyser, having low radiation attenuation. The low radiation attenuation of the adhesive reduces opportunities of creating undesired artefacts in an acquired x-ray image. The adhesive is freshly prepared before applying to one or both of the grid elements 205 and 210 as described above. With interspace bands 235 and 265 protecting the lamella 260, heat can be applied so as to speed up the curing or polymerization of the adhesive with reduced or no distortion or deformation of the protected lamella 260. Examples of techniques to apply heat include providing a hot air flow, exposing one or both interspace bands 235 and 265 to a heat radiating source, or other known techniques or combinations.

According to another embodiment, the coating of binding material 280 can include a fuse material. The fuse material is characterized to include having both a low melting temperature and a low attenuation of radiation. The fuse material can be applied to one or both interspace bands 235 and 265 before the grid elements 205 and 210 are brought together. Again, the lamellas 240 and 260 of high radiation attenuation are protected between the respective interspace bands 230, 235 and 265, 270 for reasons described above such that heat can be applied to melt the fuse material such that when allowed to cool creates a fixed connection between grid elements 205 and 210.

According to yet another embodiment, the coating of the binding material 280 can include a layer of material of high electrical resistance. An example of the electrically resistive layer can include a low atomic material and/or a submicron thickness of any material so as to cast a minimal or no shadow in the acquired x-ray image. The electrically resistive material can be applied to one or both interspace bands 235 and 265 of the grid elements 205 and 21 0, respectfully, and brought into contact with one another. When the grid elements 205 and 210 are pressed together, an electrical current is provided to induce a temperature increase so as to at least partially melt the coating of binding material 280, which when allowed to cool provides a fixed connection between the grid elements 205 and 210. For similar reasons to those described above, the interspace bands 230, 235 and 265, 270 reduce or prevent deformation of the lamellas 240 and 260 of high radiation attenuation in association with the temperature increase to melt the coating of binding material 280.

According to yet another embodiment, there is no binding material between the grid elements 205 and 210. The most closely adjacent interspace bands 235 and 265 of each grid element 205 and 210 can be comprised of the same low radiation attenuation material having a low melting temperature. With the lamellas 240 and 260 of high radiation attenuation protected between the respective interspace bands 230, 235 and 265, 270 of low radiation attenuation, a high frequency electric field or current can be applied to provoke a local temperature increase to melt the contact point between the interspace bands 235 and 265 so as to create a solder connection with reduced or no deformation of the lamellas 240 and 260 of high attenuation of the grid elements 205 and 210, respectively. The coatings 145 and 160 of binding material can be comprised of electrical conductive material so as to conduct electrical current through the grid elements 205 and 210.

A positioning or grasping tool 300 mounted on a swing arm 305 moves the grid element 205 into contact with the grid element 210. A surface of the positioning or grasping tool 300 abuts against an open face 315 of the grid element 210 as the grid element 210 is pressed against the coat of binding material 280 and the grid element 205. The tool 300 is mounted on the swing arm 305 so as to pivot about a fixed point 310 in manner such that the flat surface of the tool 300 and open face 320 of the interspace band 270 of the grid element 210 is aligned in a plane 325 extending through the reference point 310. Consequently, the grid elements 205, 210 and 215 are assembled successively such that the opposed faces of the high attenuation lamellas 240, 260, and 330 of each grid element 205, 210 and 215 respectively are aligned substantially in plane 325 extending through the reference 310.

It should be understood that the grid elements 205, 210 and 215 of the grid arrangement 200 can be connected to one another using any of the techniques or combination of techniques described above.

Although the exemplary grid arrangements 100 and 200 are illustrated with respect to a certain number of grid elements 105, 110, 115, 205, 210 and 215, it should be understood that the number of grid elements 105, 110, 115, 205, 210 and 215 can vary.

This written description uses examples to disclose the invention, including the best mode, and also to enable any person skilled in the art to make and use the invention. The scope of the subject matter described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An antiscatter grid element, comprising:
a first and a second interspace band comprised of a low radiation attenuation material attached at opposed faces of a lamella comprised of high radiation attenuation material, wherein the first and second interspace bands each include an open face in a central longitudinal direction through the first and second interspace bands and lamella, the open face operable to receive one of a first and a second interspace band of low radiation attenuation of another grid element.

2. The antiscatter grid element according to claim 1, wherein the first and second bands have a generally equal thickness in a central longitudinal direction.

3. The antiscatter grid element according to claim 1, wherein the first interspace band has a first thickness greater than a second thickness of the second interspace band in a central longitudinal direction.

4. An antiscatter grid arrangement, comprising:
a plurality of grid elements including a first grid element attached to a second grid element, each first and second grid element including a lamella of high radiation attenuation located between a first and a second interspace band of low radiation attenuation, and a fixed connection between one of the first and second interspace bands of the first grid element to one of the first and second interspace bands of the second grid element.

5. The antiscatter grid arrangement according to claim 4, wherein the fixed connection includes a coat of binding material, the coat of binding material including an adhesive layer attaching one of the first and second interspace bands of the first grid element at one of the first and second interspace bands of the second grid element.

6. The antiscatter grid arrangement according to claim 4, wherein the fixed connection includes a coat of binding material, the coat of binding material including a fusing layer applied at one of the first and second interspace bands of the first grid element abutted against one of the first and second interspace bands of the second grid element exposed to heating so as to at least partially melt the fuse layer that when allowed to, attaches the first and second grid elements together.

7. The antiscatter grid arrangement according to claim 4, wherein the fixed connection includes a coat of binding material, the coat of binding material including a layer of generally high electrical resistance material located between one of the first and second interspace bands of the first grid element and one of the first and second interspace bands of the second grid element exposed to an electrical current so as to generate a temperature increase so as to melt one of the first and second interspace bands that when cooled connects the first and second grid elements to one another.

8. The antiscatter grid arrangement according to claim 4, wherein fixed connection includes a solder connection between one of the first and second interspace bands of the first grid element and one of the first and second interspace bands of the second grid element.

9. The antiscatter grid arrangement according to claim 4, wherein one of the first and second interspace bands is comprised of one of the group of materials consisting of cellulose fiber material, polyethylene, methyl pentene copolymer, polyimide, bi-axially oriented polyethylene terephtalate, and thermoplastic material.

10. The antiscatter grid arrangement according to claim 4, wherein lamella is comprised of one of the group of materials consisting of copper, tantalum, gold, platinum, depleted uranium, tungsten and lead.

11. The antiscatter grid arrangement according to claim 4, wherein binding material is comprised of a low radiation attenuation material different than the first and second interspace bands.

12. A method of fabricating an antiscatter grid, the method comprising the acts of:
creating a plurality of grid elements, including a first grid element and a second grid element, wherein the act of creating each of the plurality of grid elements includes connecting a first interspace band comprised of a low radiation attenuation material at one face of a lamella comprised of a higher radiation attenuation, and connecting a second interspace band of low radiation attenuation material at an opposite face of the lamella, the first and second grid elements created independently of one another; and
attaching one of the first and second interspace bands of the first grid element to one of the first and second interspace bands of the second grid element.

13. The method according to claim 12, wherein the act of creating both the first and second grid elements comprises:
applying a first coat of binding material to a first interspace band of low attenuation material;
engaging the first coat of binding material against a first face of the lamella;
applying a second coat of binding material to a second interspace band of low attenuation material;
engaging the second coat of binding material against a second face of the lamella opposite the first face,
wherein the first and second grid elements are created independently.

14. The method according to claim 12, the method further comprising the act of:
pressing the first interspace band and the second interspace band in a direction toward one another and against the lamella.

15. The method according to claim 12, wherein the first and second interspace bands have a generally equal thickness relative to one another in a direction generally perpendicular to the opposed faces of the lamella.

16. The method according to claim 12, wherein the first interspace band has a first thickness greater than a second thickness of the second interspace band a direction generally perpendicular to the opposed faces of the lamella.

17. The method according to claim 12, wherein the act of attaching one of the interspace bands of the first grid element to one of the interspace bands of the second grid element includes applying a coat of binding material connecting the first and second grid elements.

18. The method according to claim 17, wherein the act of applying the coat of binding material between the first and second grid elements includes:
applying a fusing layer to an exposed face of a first of the plurality of grid elements; and
heating an exposed side of a second of the plurality of grid elements; and
applying the fusing layer of the first grid element against the exposed side of the second grid element that underwent the act of heating.

19. The method according to claim 17, wherein the act of applying the coat of binding material includes:
applying a layer of generally high electrical resistance material to one of the first and second interspace space bands of the first grid element;
abutting the layer of generally high electrical resistance of the first grid element against one of a first and a second interspace band of the second grid element; and
applying an electrical current to the layer of generally high electrical resistance so as to generate a temperature increase such that the layer of generally high electrical resistance attaches the first and second of the plurality of grid elements to one another.

20. The method according to claim 12, wherein the act of attaching the first and the second of the plurality of grid elements includes:
soldering one of the first and second interspace bands of the first grid element to one of the first and second interspace bands of the second grid element.
